(19) United States
(12) Patent Application Publication
(10) Pub. No.: US 2026/0162005 A1
(43) Pub. Date: Jun. 11, 2026

(54) TRAINING-DEVICE AND METHOD FOR TRAINING A MACHINE LEARNING MODEL

(71) Applicant: Siemens Healthineers AG, Forchheim (DE)

(72) Inventors: Ramyar BINIAZAN, Nuernberg (DE); Andreas FIESELMANN, Erlangen (DE); Wai Yan Ryana FOK, Garching b. Muenchen (DE); Christian HUEMMER, Lichtenfels (DE)

(73) Assignee: Siemens Healthineers AG, Forchheim (DE)

(21) Appl. No.: 19/177,725

(22) Filed: Apr. 14, 2025

(30) Foreign Application Priority Data
Apr. 15, 2024 (EP) 24170229.9

(51) Int. Cl. G06N 20/00; G06T 11/00

(52) U.S. Cl. CPC G06N 20/00; G06T 11/00

(57) ABSTRACT

A training-device comprises: a data-generator to generate synthetic training-images from a first set of parameter-values and synthetic testing-images from a second set of parameter-values, wherein the parameter-values are from a common parameter-set, and each image is linked to a ground truth; a training-unit to train a machine learning model with training-images in a supervised manner; and a testing-unit to test a trained model based on testing-images, evaluate individual test-qualities, and determine parameter value-ranges for groups of testing-images representing ranges with a relatively poor image-density, wherein at least one of (i) test-qualities are below a threshold value or (ii) the relative number of training-images compared to other parameter value-ranges is below a threshold. The training-device is configured to: feed the parameter value-ranges back to the data-generator; generate additional synthetic training-images based on the parameter value-ranges; and further train the model with the additional synthetic training-images.

### CROSS-REFERENCE TO RELATED APPLICATION(S)

The present application claims priority under 35 U.S.C. § 119 to European Patent Application No. 24170229.9, filed Apr. 15, 2024, the entire contents of which is incorporated herein by reference.

### FIELD

One or more embodiments of the present invention describe a training-device and a method for training a machine learning model.

### BACKGROUND

Deep Learning has revolutionized medical software applications by improving diagnostic accuracy, enabling workflow automation, and enhancing patient care. However, the effectiveness of deep learning models in healthcare relies on representative data, particularly in recognizing rare medical conditions. An under-representation of training data can lead to poor model performance and impede their full potential in addressing critical medical challenges. In general, the problem lies in an under-representation in training data and/or an under-representation in testing data.

When deep learning models are trained on datasets that under-represent rare conditions (“under-representation in training data”), they may not learn to recognize these conditions effectively. The model tends to bias toward the majority class, leading to poor performance when it encounters rare conditions in real-world scenarios.

On the other hand, by not providing enough rare cases in testing dataset (“under-representation in testing data”), the performance of trained models on rare cases is unknown and therefore not reliable.

Previous studies also explored the use synthetic data to compensate underrepresented cases in either training and testing or both.

Concerning training, the study by Sukesh et al. 2022 (“Training deep learning models for 2D spine x-rays using synthetic images and annotations created from 3D CT volumes”, Bildverarbeitung für die Medizin 2022: Proceedings, German Workshop on Medical Image Computing, Heidelberg, (pp. 63-68), Jun. 26-28, 2022) added synthetic spine X-ray data from CT volumes to real X-ray data to improve the network performance in vertebrae detection. The study from Gao et al. 2023 (“Synthetic data accelerates the development of generalizable learning-based algorithms for X-ray image analysis”, Nature Machine Intelligence, 5(3), 294-308, 2023) used synthetic X-ray data from realistic simulation and strong domain randomization of CT volumes to train models for clinical tasks such as surgical tool and landmark detection, hip and lung lesion segmentation. Both studies used synthetic X-ray in training and real X-ray for testing.

Concerning testing, the study by Fok et al. 2023 (“Learning Patient Rotation Using Synthetic X-ray Images from 3D CT Volumes”, Medical Imaging with Deep Learning, short paper track”, 2023) used synthetic X-ray data from CT volumes to train and test the model for learning internal patient rotation. The estimation of patient rotation angle is less accurate in large angles, but no feedback is yet provided to generate more synthetic X-ray with large angles for further training.

However, the current challenge is whether the synthetic data could cover all rare conditions and the combinations of them, in terms of patient positioning, pathologies, image quality, etc.

### SUMMARY

The current methods only showed the direct generation of synthetic X-ray data from CT data for training without evaluating the synthetic data in testing nor giving feedback to the synthetic data generator.

Therefore, one or more embodiments of the present invention aim to at least improve the synthetic data generation based on testing performance by generating new combinations of underrepresented distribution in different conditions, so as to ensure the trained network (model) is robust to different multivariate distribution.

It is an object of one or more embodiments of the present invention to improve the known systems and methods and provide a training-device and a method for training a machine learning model for overcoming the above described problems.

At least this object is achieved by a training-device and a method as claimed.

A training-device according to an embodiment of the present invention serves for training a machine learning model. It comprises a training-unit, a testing-unit and a data-generator.

The data-generator is designed to generate synthetic training-images from a first set of parameter-values and synthetic testing-images from a second set of parameter-values, wherein all parameter-values are values of a common predefined parameter-set, and each image is linked to a ground truth.

The training-unit is designed to train a machine learning model with training-images in a supervised manner.

The testing-unit is designed to
a) test a trained model based on testing-images,
b) evaluate individual test-qualities of the test for single testing-images, and
c) determine parameter value-ranges for groups of testing-images representing ranges with a relatively poor image-density, where test-qualities are below a predefined threshold value, and/or the relative number of training-images compared to other parameter value-ranges is below a predefined threshold.

The training-device is further designed to feed the parameter value-ranges back to the data-generator, generate additional synthetic training-images based on the determined parameter value-ranges, wherein each synthetic training-image is linked to a ground truth, and further train the model with the additional synthetic training-images.

Training-devices comprising a training-unit and a testing-unit are well known in the art. They could train a machine learning model with training-images and use testing-images for testing the state and the capabilities of the trained model. As said above, Training could be performed with real training-images and also with synthetic training-images.

Machine learning models are well known in the art. For segmenting-images, especially convolutional networks are advantageous for one or more embodiments of the present invention, since they could be used for effectively segment images.

Training-units designed to train a machine learning model with training-images in a supervised manner are well known in the art. They can be fed with training-images comprising or linked to a ground truth and train a machine learning model. The training-images may comprise the ground truth, e.g. labels labeling certain areas of the training-images or be linked to a ground truth, e.g. the training-unit knows that the next images all show certain objects.

Testing-units designed to test a trained model based on testing-images and evaluate individual test-qualities of the test for single testing-images are also well known.

The training device according to one or more embodiments of the present invention is special, because it also comprises a data-generator and is designed to feed back parameter value-ranges of very special results from the testing step in order to selectively generate special training-images.

Also, data-generators are known in the art, that are able to generate synthetic images (training-images as well as testing-images) with or without a ground truth.

To begin with, the testing-unit has the special ability to determine parameter value-ranges for groups of testing-images representing ranges with a relatively poor image-density. In these ranges, test-qualities are below a predefined threshold value, and/or the relative number of training-images compared to other parameter value-ranges is below a predefined threshold.

The parameters of the images should generally stay the same, e.g. parameters concerning-image acquisition (e.g. parameters of an X-ray beam), the position of the recorded object, the angle of view, and maybe environmental conditions. However, the values of the parameters vary over the training-images. Now, there may be many images taken with “normal” parameter values and only a few images taken with “exotic” parameter values.

Typically, the testing with testing-images acquired with “exotic” parameter values will result in poor testing results, since also the training-images with “exotic” parameter values were not sufficient for training due to the low number. Thus, the test-qualities of such images are generally below a predefined threshold value. In addition or alternatively, the images could also be simply counted. In the case there are only a few images in a certain value-range (while there are many images in other value-ranges comparable in range-size), it could be decided that the relative number of training-images compared to other parameter value-ranges is below a predefined threshold and that there is a poor image density. However, since it is not always known, whether a certain value-range is of special interest, testing results are preferred for determining whether there is a poor image density or not.

Thus, the testing-unit is designed to output value-ranges for a certain number of parameters where a poor image density has been detected. This value-range may concern only one single parameter, e.g. a certain angle of view or a certain beam intensity, but may also concern two or more parameters. e.g. a certain angle of view at a certain beam intensity. However, this issue may be getting complicated with a great number of parameters.

Concerning the value-ranges, the training-device is designed to feed the parameter value-ranges back to the data-generator.

The data-generator of the training device according to one or more embodiments of the present invention is designed to generate synthetic training-images (with a ground truth or linked to a ground truth) from a given set of parameter-values. Since the parameter-values used for training-images and testing-images may differ, it is said that a first set of parameter-values is used for generating synthetic training-images and a second set of parameter-values is used for generating synthetic testing-images. In general, the first set of parameter-values θt (training) and the second set of parameter-values θv (testing or “validation”) are preferably different because only θt is updated and θv is left unchanged (as it is advantageous for testing consistency when the validation images are not changing). It should be noted that the result on the validation dataset can be evaluated and if seen that cases with certain parameter values tend to fail, those parameter values could be overrepresented in θt (e.g. in terms of numbers of samples to be created).

When there is a number of value-ranges fed back by the training device, the data-generator will generate synthetic images (that are then used as training-images, but may also be used as testing-images) based on the determined parameter value-ranges. Again, each synthetic training-image is linked to a ground truth for supervised training. It is preferred that the images are generated by clinging to the given parameter value-ranges for certain parameters, and to vary parameter values for other parameters to get a broader bandwidth of possible cases. Thus, in the case there is a value-range given for the angle of view, the generator varies in this range only for the angle of view, but varies broadly over beam intensity not restricted. There could easily be defined change-ranges in which certain parameters can change in one of said value-ranges.

With these additional synthetic training-images the model is further trained. Since they are pertaining to certain parts of the parameter values where there have been only a few images, the model could purposefully be trained for a certain “rare condition”.

A method according to an embodiment of the present invention serves for training a machine learning model. The method is performed with a training-device according to an embodiment of the present invention and comprises the following steps:
a) providing training-images and testing-images,
b) training of the model with the training-images,
c) testing the trained model based on the testing-images, wherein individual test-qualities are evaluated for single testing-images, and parameter value-ranges are determined for groups of testing-images, representing ranges with a relatively poor image-density, where test-qualities are below a predefined threshold value, and/or the relative number of training-images compared to other parameter value-ranges is below a predefined threshold,
d) generating synthetic training-images and preferably also synthetic testing-images with the data-generator based on the evaluated set of parameter value-ranges,
e) repeating at least steps b) and c) with the generated synthetic training-images and preferably also with generated synthetic testing-images.

The functions of the components of the training-device have been explained above.

First, there are provided training-images and testing-images (with or combined with a ground truth). These images could be real images or synthetic images or both. Since an important application is medicine especially X-ray imaging, the images could be medical images, especially X-ray images.

Then, the machine learning model is trained with the training-images. Such training is well known in the art.

After that, the trained model is tested based on the testing-images. In the course of this testing, individual test-qualities are evaluated for single testing-images. These test-qualities are important for evaluating the trained model, but could also be used for the training of “rare conditions”.

Also in the course of the testing, parameter value-ranges are determined for groups of testing-images, representing ranges with a relatively poor image-density. Such ranges with a relatively poor image-density are ranges of parameter values where test-qualities are below a predefined threshold value and/or the relative number of training-images compared to other parameter value-ranges is below a predefined threshold. Thus, poor image density may be found by poor testing results or maybe also by counting-images in certain value-bins. Generally, it could be said, where there are only a few images, training of the model will be not very effective. The regions where there are only a few images could be detected by counting-images in value-range-bins or by testing the model on testing-images.

In the case, value-ranges are found with a relatively poor image-density, the training could be biased for these ranges by providing more images of these value-ranges and training the model with these images.

Thus, in the next step, synthetic training-images are generated with the image generator based on the evaluated set of parameter value-ranges. Also synthetic testing-images could be generated with the data-generator in order to specifically test the “rare condition”, however, this is not absolutely necessary.

Now, at least steps b) and c) of the method (training and testing) are repeated with the new synthetic training-images. The testing may be done with new synthetic testing-images or with the old images.

For better results, more iterations could be made by determining other value-ranges with “rare condition” and producing training-images (and possibly also testing-images) for different value-ranges. Every new cycle will be the proceeding of steps d), e), b) and c).

Some units or modules of embodiments of the present invention mentioned above can be completely or partially realized as software modules running on a processor of a computing system. A realization largely in the form of software modules can have the advantage that applications already installed on an existing computing system can be updated, with relatively little effort, to install and run these units of the present application. An object of one or more embodiments of the present invention is also achieved by a (non-transitory) computer program product with a computer program that is directly loadable into the memory of a computing system, and which comprises program units to perform the steps of the methods, at least those steps that could be executed by a computer, when the program is executed by the computing system. In addition to the computer program, such a computer program product can also comprise further parts such as documentation and/or additional components, also hardware components such as a hardware key (dongle etc.) to facilitate access to the software.

A non-transitory computer readable medium such as a memory stick, a hard-disk or other transportable or permanently-installed carrier can serve to transport and/or to store the executable parts of the computer program product so that these can be read from a processor unit of a computing system. A processor unit can comprise one or more microprocessors or their equivalents.

Particularly advantageous embodiments and features of the present invention are given by the dependent claims, as revealed in the following description. Features of different claim categories may be combined as appropriate to give further embodiments not described herein.

It is preferred that the data-generator is designed to generate synthetic medical images, preferably synthetic X-ray images in form of projection images and/or tomographic images. It is particularly preferred that a set of parameter-values comprises values of one or more parameters of the group X-ray tube viewing angle, patient positioning, collimation, image quality (especially noise or sharpness), X-ray post-processing parameters (e.g. flavors), anatomical variations, anatomical pathologies and foreign objects (e.g. implants, lines or tubes).

In a preferred case, there are used three dimensional images, especially CT-images, in order to generate synthetic X-ray projection images. A projection vector could be defined for a 3D-image defining the angle of view and the 3D-image could be projected on a plane having the projection vector as normal plane-vector. Thus, preferably, the data-generator is designed to generate synthetic X-ray projection images generated by forward projecting 3D computertomographic images on a 2D-plane.

It is further preferred that the data-generator is designed to emulate a virtual detector acquiring the projected image and preferably also to process the resulting-image with a number of X-ray image processing algorithms. Such algorithms are known in the art and could be used to slightly alter images concerning special parameters.

A preferred embodiment of the training-device comprises a data-interface designed to receive and/or fetch real training-images. and wherein the training-device is designed to use the real images as training-images for training the model and/or as testing-images for testing the trained model. A mixture of real and synthetic training-images is advantageous, since the synthetic images are numerous and the real images show real content.

A preferred embodiment of the training-device is designed to evaluate recording-parameter-values of the real images. These real images could then be used as testing-images. In addition, the training-device is preferably designed to count the real images for predefined value-ranges of the recording-parameter-values, determine a number of value-ranges with the fewest number of images and feed these value-ranges back to the data-generator in order to create additional synthetic training-images. Thus, “rare conditions” of real images could be determined and additional synthetic training-images could be provided to train the model for these rare conditions.

As said above, the testing is a very good indicator of rare conditions. Thus, the testing-unit is preferably designed for:
selecting testing-images with test qualities below a predefined quality-threshold,
evaluating patterns in the second sets of parameter-values of these testing-images (in order to estimate value-ranges of “rare conditions”),
determining parameter value-ranges from these patterns,
forming a first set of parameter-values based on the determined value-ranges.

Preferably, the training-device comprises a pre-augmentation-unit designed to evaluate the (synthetic, but possibly also real) training-images created by the data-generator for their value for training and delete images not usable for training. Preferably, the pre-augmentation-unit is designed to determine a numerical value, compare this value with a numerical range and delete an image or mark an image to be deleted in the case the value lies out of the range.

Regarding a preferred method, for step a) (providing training-images and testing-images), at least a part of the training-images and/or the testing-images are synthetic images generated by the data-generator.

Concerning a preferred method, the image-density of parameter value-ranges are evaluated by evaluating the performance on the testing of testing-images. When the trained model has poor performance on specific cases, respective parameter value-ranges are determined. In an easy example, the parameter values of said specific cases are examined and when there are certain groups of specific cases with similar parameter values, these parameter values could be taken as value-range for generating new training-images.

Preferably, the image-density of parameter value-ranges are evaluated by counting the images in each value-range and normalizing the counted values (in order to get value-ranges with relatively few images compared to other value-ranges). It is preferred that the image-density of parameter value-ranges are evaluated by counting the images with a specific test result (e.g. fail/pass) in each range and normalizing the counted values.

Preferably, parameter value-ranges are defined by prior knowledge about a relatively poor image-density in these value-ranges and synthetic training-images are generated by the synthetic data generator, and preferably also synthetic testing-images for testing.

Preferably, multiple training-iterations are performed with synthetic training-images, and especially also with synthetic testing-images, based on certain sets of parameter-values. It is particularly preferred that during each training iteration sets of parameter-values are evaluated from the testing-images and if testing-images of a set of parameter-values perform poorly, this set of parameter-values is prioritized as new first set of parameter-values in the next iteration, prompting the generator to produce more data with those first set of parameter-values.

Preferably, the training is based on supervised learning, while each training-image and testing-image is connected with or comprises an individual ground truth, preferably wherein the training is performed in order to segment the images and/or classify elements of the images and/or detect objects in the images. Preferably, the model is trained for bone segmentation in an image.

The methods may also include elements of “cloud computing”. In the technical field of “cloud computing”, an IT infrastructure is provided over a data-network, storage space or processing power and/or application software. The communication between the user and the “cloud” is achieved via data interfaces and/or data transmission protocols. In the context of “cloud computing”, in a preferred embodiment of the methods according to the present invention, provision of data via a data channel (for example a data-network) to a “cloud” takes place. This “cloud” includes a (remote) computing system, e.g. a computer cluster that typically does not include the user's local machine. It is particularly preferred that the cloud service provides as well computing power as application software.

Thus, embodiments of the present invention aims to improve the synthetic data generation based on testing performance by generating new combinations of underrepresented distribution in different conditions, so to ensure trained network is robust to different multivariate distribution. The advantages of one or more embodiments of the present invention are the feedback loop that is used to update synthesis parameters in the data generator. Thus the data generator is by design creating samples with high relevance for the training. On the other hand, the workflow may include separate testing on real and synthetic data enabling testing on rare cases (mostly synthetic data) and also common cases (mostly real data). Applying one or more embodiments of the present invention can mitigate underrepresented case in training and testing data.

### BRIEF DESCRIPTION OF THE DRAWINGS

Other objects and features of the present invention will become apparent from the following detailed descriptions considered in conjunction with the accompanying drawings. It is to be understood, however, that the drawings are designed solely for the purposes of illustration and not as a definition of the limits of the present invention.

FIG. 1 shows a training-device according to embodiments of the present invention,

FIG. 2 shows a block diagram of the method according to embodiments of the present invention.

### DETAILED DESCRIPTION

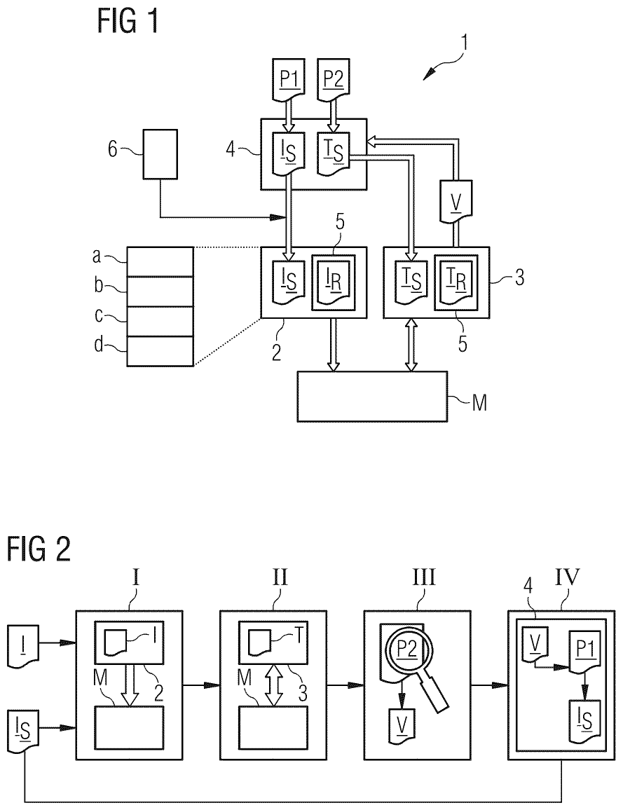

FIG. 1 shows an example of a training-device 1 according to embodimemts of the present invention for training a machine learning model M. The training-device 1 comprises a training-unit 2, a testing-unit 3 and a data-generator 4.

The training-unit 2 is designed to train a machine learning model M with training-images I in a supervised manner. In this example, it comprises an in-training augmentation unit a, a data pre-processing-unit b, an optimization unit c and a validation unit d. Such training-units are well known. The validation unit d is commonly used for checking if training works properly and to avoid overfitting. Also, the data in the validation unit d could be a subset of the training data. Thus the validation unit d is different from the testing-unit 3 of an embodiment of the present invention.

In the shown example, the training-device 1 comprises a data-interface 5 designed to receive and/or fetch real training-images IR and wherein the training-device 1 is designed to use the real images as training-images IR for training the model M and/or as testing-images TR for testing the trained model M.

The data-generator 4 is designed to generate synthetic training-images IS from a first set of parameter-values P1 and synthetic testing-images TS from a second set of parameter-values P2, wherein all parameter-values P1, P2 are values of a common predefined parameter-set, and each image I, T is linked to a ground truth.

The testing-unit 3 is designed to test a trained model M based on testing-images T, evaluate individual test-qualities of the test for single testing-images T, and determine parameter value-ranges V for groups of testing-images T representing ranges with a relatively poor image-density, where test-qualities are below a predefined threshold value, and/or the relative number of training-images I compared to other parameter value-ranges V is below a predefined threshold.

The training-device 1 is further designed to feed the parameter value-ranges V back to the data-generator 4, generate additional synthetic training-images IS based on the determined parameter value-ranges V, wherein each synthetic training-image IS is linked to a ground truth, and further train the model M with the additional synthetic training-images IS.

The images I, T may be X-ray images in form of projection images and/or tomographic images and the set of parameter-values P1, P2 could comprises values of one or more parameters of the group X-ray tube viewing angle, patient positioning, collimation, image quality, X-ray post-processing parameters, anatomical variations, anatomical pathologies and foreign objects. In that case, the data-generator 4 may be designed to generate synthetic X-ray projection images generated by forward projecting 3D computertomographic images on a 2D-plane, preferably wherein the data-generator 4 is designed to emulate a virtual detector acquiring the projected image and preferably also to process the resulting-image with a number of X-ray image processing algorithms.

As said above, a key component of one or more embodiments of the present invention is the (synthetic) data generator 4. This component creates e.g. synthetic X-ray images IS, TS given a set of synthesis parameters θ (with defined parameter values). Examples for synthesis parameters can be: X-ray tube viewing angle, patient positioning, collimation and/or image quality (noise, sharpness) and/or X-ray post-processing parameters (flavors) and/or anatomical variations/pathologies, foreign objects (implants, lines and tubes). The task of this data generator 4 is to create different synthetic X-ray images from different synthesis parameters θ. A practical implementation can be using CT volumes that are forward projected onto a virtual detector and the detector image is processed with x-ray image processing algorithms.

The data generator 4 may create images both for the training of the model M and for the testing of the model M. The parameter sets for creating the training data could be denoted as θti (i=1, . . . , Nt; first set of parameter values P1) whereas θvi (i=1, . . . , Nv; second set of parameter values P2) denotes the parameter sets for the testing/validation data.

As shown above, a key element of one or more embodiments of the present invention is to update the synthesis parameters (first set of parameter values P1) for the data generator 4 during training and/or after testing.

After Testing: Successful model training is determined by its performance on a testing dataset with real clinical cases. When the trained model M has poor performance on specific cases, this will guide the creation of a new set of first parameter values P1 for the data generator 4. This set is then used to represent specific data in both the training and validation datasets.

During Training: Synthetic data representing rare clinical images (based on rare pathologies, acquisition parameters, patient positioning, etc.) are incorporated into the training and validation datasets. Each training epoch evaluates parameter sets in the testing data. If a set performs poorly, it is prioritized in the next epoch, prompting the generator to produce more data with those parameters.

FIG. 2 shows a block diagram of the method according to embodiments of the present invention for training a machine learning model M with a training-device 1 as e.g. shown in FIG. 1.

There are provided training-images I and testing-images T. The provision of training-images I is indicated at the left of the blocks. The training-images I and testing-images may be real images and/or synthetic images generated by the data-generator 4.

In step I, the model M is trained with the training-images I. The training is based on supervised learning, while each training-image and testing-image is connected with or comprises an individual ground truth, preferably wherein the training is performed in order to segment the images and/or classify elements of the images and/or detect objects in the images.

In step II, the trained model M is tested based on the testing-images T.

In step III, individual test-qualities are evaluated for single testing-images T, and parameter value-ranges V are determined for groups of testing-images T, representing value-ranges V with a relatively poor image-density, where test-qualities are below a predefined threshold value, and/or the relative number of training-images I compared to other parameter value-ranges V is below a predefined threshold.

The image-density of parameter value-ranges V could be evaluated by evaluating the performance of the testing with testing-images T, and when the trained model M has poor performance on specific cases, respective parameter value-ranges V are determined. However, they could also be evaluated by counting the images in each range and normalizing the counted values. Preferably, the image-density of parameter value-ranges V could be evaluated by counting the images with a specific test result in each range and normalizing the counted values.

In step IV, synthetic training-images IS are generated with the data-generator 4 based on the evaluated set of parameter value-ranges V.

Then, the training and testing (steps I and II) are repeated with the generated synthetic training-images IS. Steps III and IV could also be repeated (again followed by steps I and II) for another iteration. Multiple training-iterations could be performed with synthetic training-images IS, based on certain sets of parameter-values P1, preferably wherein during each training iteration sets of parameter-values P1 are evaluated from the testing-images T and if testing-images T of a set of parameter-values P2 perform poorly, this set of parameter-values P2 is prioritized as new first set of parameter-values P1 in the next iteration, prompting the generator to produce more data with this first set of parameter-values P1.

For example, from the evaluation on another synthetic X-ray test data, it is found that the estimation of patient rotation angle is less accurate in large angles. However, there is not yet feedback to generate more synthetic X-ray with large angles for further training. According to an embodiment, the present invention would first evaluate the trained model M in both real and synthetic test data. If the performance in synthetic data does not fulfill the criteria, according to an embodiment, the present invention will evaluate the test data performance with respect to the parameter sets θti, to identify whether the ‘rotation angle’ is the parameter contributing to the performance. Then, according to an embodiment, the present invention will perform a search in this parameter space to identify which ‘rotation angles’ need to be fed to generator for generating new synthetic X-ray. Moreover, this ‘rotation angle’ parameter would be combined with other parameters, i.e. generate new parameter sets, such as pathological condition, noise, image quality when generating the new synthetic X-ray. For instance, by varying low to high noise, varying scatter effect, or by varying a pathological image impression.

For the sake of clarity, it is to be understood that the use of “a” or “an” throughout this application does not exclude a plurality, and “comprising” does not exclude other steps or elements. The expression “a number of” means “at least one”. The mention of a “unit” or a “device” does not preclude the use of more than one unit or device. Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,“ ”connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. A training-device for training a machine learning model, the training-device comprising:
a data-generator configured to generate (i) synthetic training-images from a first set of parameter-values and (ii) synthetic testing-images from a second set of parameter-values, wherein the parameter-values are values of a common parameter-set, and each image is linked to a ground truth;
a training-unit configured to train the machine learning model with training-images in a supervised manner; and
a testing-unit configured to
test the trained machine learning model based on testing-images,
evaluate individual test-qualities of the test for single testing-images, and
determine parameter value-ranges for groups of testing-images representing ranges with a relatively poor image-density, wherein at least one of
test-qualities are below a threshold value, or
a relative number of training-images compared to other parameter value-ranges is below a threshold, and wherein
the training-device is configured to
feed the parameter value-ranges back to the data-generator,
generate additional synthetic training-images based on the parameter value-ranges, wherein each additional synthetic training-image is linked to a ground truth, and
further train the machine learning model with the additional synthetic training-images.

2. The training-device according to claim 1, wherein the data-generator is configured to generate synthetic medical images.

3. The training-device according to claim 2, wherein the data-generator is configured to generate synthetic X-ray projection images generated by forward projecting 3D computer tomographic images on a 2D-plane.

4. The training-device according to claim 1, further comprising:
a data-interface configured to at least one of receive or fetch real training-images, and wherein
the training-device is configured to use the real training-images as at least one of (i) training-images for training the machine learning model or (ii) testing-images for testing the trained machine learning model.

5. The training-device according to claim 4, wherein the training-device is configured to
evaluate recording-parameter-values of the real training-images,
count the real training-images for value-ranges of the recording-parameter-values,
determine value-ranges with a fewest number of images, and
feed the determined value-ranges back to the data-generator to create the additional synthetic training-images.

6. The training-device according to claim 1, wherein the testing-unit is configured to
select testing-images with test qualities below a quality-threshold,
evaluate patterns in second sets of parameter-values of the selected testing-images,
determine parameter value-ranges from the patterns, and
form a first set of parameter-values based on the determined parameter value-ranges.

7. A method for training a machine learning model with the training-device according to claim 1, the method comprising:
providing training-images and testing-images;
training the machine learning model with the training-images;
testing the trained machine learning model based on the testing-images, wherein individual test-qualities are evaluated for single testing-images, and parameter value-ranges are determined for groups of testing-images representing value-ranges with a relatively poor image-density, wherein at least one of test-qualities are below a threshold value or a relative number of training-images compared to other parameter value-ranges is below a threshold;
generating synthetic training-images with the data-generator based on the parameter value-ranges; and
repeating at least the training with the synthetic training-images.

8. The method according to claim 7, wherein at least a part of at least one of the training-images or the testing-images are synthetic images generated by the data-generator.

9. The method according to claim 7, wherein
an image-density of the parameter value-ranges is evaluated by evaluating a performance of the testing with the testing-images, and
when the trained machine learning model has poor performance on specific cases, respective parameter value-ranges are determined.

10. The method according to claim 7, wherein an image-density of the parameter value-ranges is evaluated by counting the images in each parameter value-range and normalizing the values counted.

11. The method according to claim 7, wherein
parameter value-ranges are defined by prior knowledge about a relatively poor image-density in the parameter value-ranges, and
synthetic training-images are generated by the data-generator.

12. The method of claim 7, further comprising:
generating synthetic testing-images with the data-generator based on the parameter value-ranges; and
repeating at least the training and the testing with the synthetic training-images and the synthetic testing-images.

13. The method according to claim 12, wherein multiple training-iterations are performed with synthetic training-images and synthetic testing-images, based on certain sets of parameter-values.

14. The method according to claim 7, wherein the training is based on supervised learning, and each training-image and testing-image is connected with or comprises an individual ground truth.

15. A non-transitory computer program product comprising instructions that, when executed by a computer, cause the computer to carry out the method of claim 7.

16. A non-transitory computer-readable storage medium comprising instructions that, when executed by a computer, cause the computer to carry out the method of claim 7.

17. The training-device according to claim 2, wherein the synthetic medical images are synthetic X-ray images including at least one of projection images or tomographic images.

18. The training-device according to claim 17, wherein a set of parameter-values, among the first set of parameter-values and the second set of parameter-values, comprises values of one or more parameters including at least one of an X-ray tube viewing angle, patient positioning, collimation, image quality, X-ray post-processing parameters, anatomical variations, anatomical pathologies or foreign objects.

19. The training-device according to claim 3, wherein the data-generator is configured to
emulate a virtual detector acquiring a synthetic X-ray projection image, and
process a resulting-image with a number of X-ray image processing algorithms.

20. The method according to claim 10, wherein the image-density of the parameter value-ranges are evaluated by counting the images with a specific test result in each parameter value-range and normalizing the values counted.

21. The method according to claim 13, wherein
during each training iteration, sets of parameter-values are evaluated from the testing-images, and
when testing-images of a set of parameter-values perform poorly, the set of parameter-values is prioritized as new first set of parameter-values in a next iteration, prompting the data-generator to produce more data with the first set of parameter-values.

22. The method according to claim 14, wherein the training is performed to at least one of segment the images, classify elements of the images or detect objects in the images.
